(19) United States
(12) Patent Application Publication
(10) Pub. No.: US 2004/0264059 A1
(43) Pub. Date: Dec. 30, 2004

(54) Self aligning rotatable member

(76) Inventors: TakKoon Ooi, Singapore (SG); Yiren Hong, Singapore (SG); YongJie Tang, Singapore (SG); ChorShan Cheng, Singapore (SG); Mo Xu, Singapore (SG)

Correspondence Address: Derek J. Berger, Seagate Technology LLC, Intellectual Property - COL2LGL, 389 Disc Drive, Longmont, CO, 80503, US

(21) Appl. No.: 10/607,336

(22) Filed: Jun. 26, 2003

(51) Int. Cl. G11B 5/54

(52) U.S. Cl. 360/264.7

(57) ABSTRACT

An apparatus comprising a self-aligning rotatable member arranged between opposing first and second plate members, and a method of installation thereof. The plate members have respective first and second interior sidewalls to define respective first and second apertures therein. The rotatable member includes a central body portion and opposing, axially aligned first and second protrusions sized to rotate within the respective first and second apertures when the central body portion is placed in a gap between the plate members. During installation, the first protrusion of the rotatable member is inserted into the first aperture, and the rotatable member will tend to incur some amount of tilt. As the second plate member is lowered onto the rotatable member, the second interior sidewall contactingly engages a tapered outer surface of the second protrusion, thereby guiding the second protrusion into the second aperture and aligning the rotatable member with the apertures.

### FIELD OF THE INVENTION

This invention relates generally to the field of mechanical devices and more particularly, but not by way of limitation, to a method and apparatus for aligning a rotatable member between two fixed plate members, such as a rotatable inertial latch supported between opposing pole pieces in a data storage device voice coil motor.

### BACKGROUND

Disc drives are digital data storage devices which store and retrieve large amounts of data in a fast and efficient manner. The data are magnetically recorded on the surfaces of one or more rigid data storage discs affixed to a spindle motor for rotation at a constant high speed.

An array of vertically aligned data transducing heads are controllably positioned by an actuator to read data from and write data to tracks defined on the recording surfaces. The heads are configured to be aerodynamically supported over the recording surfaces by air currents established by the high speed rotation of the discs.

When the disc drive is deactivated, it is common to retract the actuator to a parked position. A latch is typically employed to secure the actuator and prevent the heads from inadvertently moving out onto the disc recording surfaces while the disc drive is in a deactivated state.

While various actuator latch configurations have been proposed, there remains a continued need for improved approaches to latching an actuator in a data storage device. More generally, there is a continued need for improvements in the configuration and installation of a rotatable member between adjacent plate members in any number of various applications. It is thus to these and other improvements that the present invention is directed.

### SUMMARY OF THE INVENTION

As exemplified herein, embodiments of the present invention are generally directed to an apparatus comprising a self-aligning rotatable member arrangeable between opposing first and second plate members, and a method of installation thereof.

In accordance with preferred embodiments, the opposing first and second plate members preferably comprise magnetically permeable pole pieces of a voice coil motor (VCM) used in a data storage device to controllably move a rotary actuator, although other types of plate members can readily be used as well. The plate members have respective first and second interior sidewalls which define respective first and second apertures.

The rotatable member preferably comprises an actuator latch utilized in the data storage device to latch the actuator in a parked position, although other types of rotatable members can be employed as well. The rotatable member includes a central body portion and opposing, axially aligned first and second protrusions sized to rotate within the respective first and second apertures when the central body portion is placed in a gap between the first and second plate members.

The first protrusion preferably comprises a first outer surface sized to abut the first interior sidewall. The second protrusion preferably comprises a second outer surface sized to abut the second interior sidewall, as well as a tapering third outer surface which converges from the second outer surface.

Because the first protrusion is configured to freely rotate within the first aperture, the effective diameter of the first aperture will generally be a little larger than the effective diameter of the first protrusion. Hence, placement of the rotatable member onto the first plate member with the first protrusion extending into the first aperture may result in some amount of tilt being induced in the rotatable member as the rotatable member “leans” to one side or the other.

The first, second and third outer surfaces are configured to take this potential tilting of the rotatable member into account. That is, when the first protrusion is inserted into the first aperture, the second interior sidewall contactingly engages the third outer surface and guides the second protrusion into the second aperture as the second plate member is brought into axial alignment with the first plate member. Thus, as the second plate member moves to the final desired position, the rotatable member is moved to a final axial alignment with the first and second apertures.

The apparatus further preferably comprises a structure (such as a standoff post) to secure the second plate member with respect to the first plate member so that the rotatable member is captured between the first and second members. Preferably, the first outer surface of the first protrusion has a first diameter and the second outer surface of the second protrusion has a second diameter greater than the first diameter. The tapered third outer surface of the second protrusion preferably tapers to a smaller diameter than that of the first protrusion.

The second interior sidewall preferably includes an annular portion and a chamfered portion which extends from the annular portion. The annular portion is sized to surround and abut the second outer surface of the second protrusion, and the chamfered portion is configured to contact the tapered outer surface as the second protrusion is guided into the second aperture.

In further preferred embodiments, the method generally includes steps of providing a rotatable member and opposing first and second plate members as configured above. The first protrusion of the rotatable member is inserted into the first aperture of the first plate member. As mentioned above, this may tend to result in some amount of tilt in the rotatable member.

The second plate member is lowered onto the rotatable member so that the second interior sidewall is placed onto the tapered outer surface of the second protrusion. The second interior sidewall is then advanced along the tapering outer surface to guide the second protrusion into the second aperture as the second plate member is brought into axial alignment with the first plate member. As before, this results in the rotatable member being axially aligned with the first and second apertures once the second plate member is in the final desired position.

Preferably, an additional step is carried out to secure the second plate member with respect to the first plate member to capture the rotatable member between the first and second plate members.

These and various other features and advantages which characterize the claimed invention will be apparent from a reading of the following detailed description and a review of the associated drawings.

### BRIEF DESCRIPTION OF THE DRAWINGS

FIG. 1 is a top plan view of a disc drive data storage device constructed in accordance with preferred embodiments of the present invention.

FIG. 2 provides a cross-sectional, elevational view of a voice coil motor (VCM) of FIG. 1 to illustrate first (lower) and second (upper) plate members.

FIG. 3 is a top plan view of a rotatable member (latch) of the device of FIG. 1.

FIGS. 4-8 show various illustrative views of the rotatable member of FIG. 3 in conjunction with the first and second plate members of FIG. 2.

FIG. 9 shows the rotatable member and the second plate member in greater detail in accordance with a preferred embodiment.

FIG. 10 shows the rotatable member and the second plate member in greater detail in accordance with another preferred embodiment.

FIG. 11 provides a flow chart for a ROTATABLE MEMBER INSTALLATION routine generally representative of steps carried out in accordance with preferred embodiments of the present invention.

### DETAILED DESCRIPTION

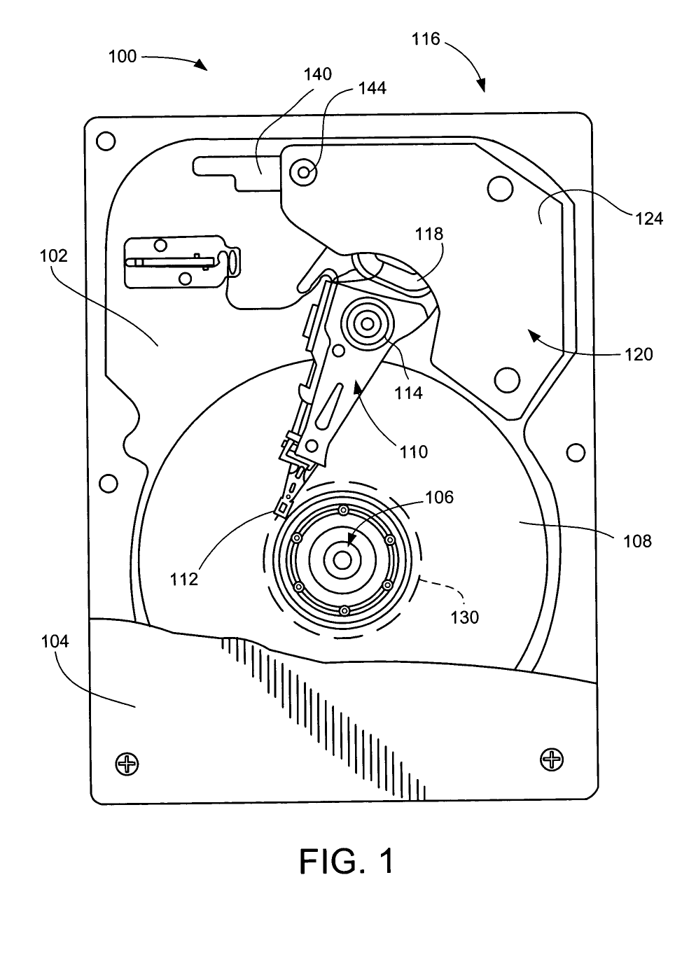

To provide an illustrative environment in which preferred embodiments or the present invention can be advantageously practiced, FIG. 1 shows a top view of a disc drive data storage device 100 of the type used to store and retrieve computerized user data.

The disc drive 100 includes a base deck 102 and a top cover 104 (shown in partial cutaway) that cooperate to form a sealed housing. A spindle motor 106 supports and rotates a number of axially aligned storage discs 108 at a constant operational speed. Recording surfaces of the discs include a number of concentric tracks (not shown) to which data are stored and from which data are retrieved during operation.

A rotary actuator 110 is mounted to the base deck 102 adjacent the discs 108 and supports a corresponding array of data transducing heads 112. The actuator 110 is rotated about a cartridge bearing assembly 114 by a voice coil motor (VCM) 116.

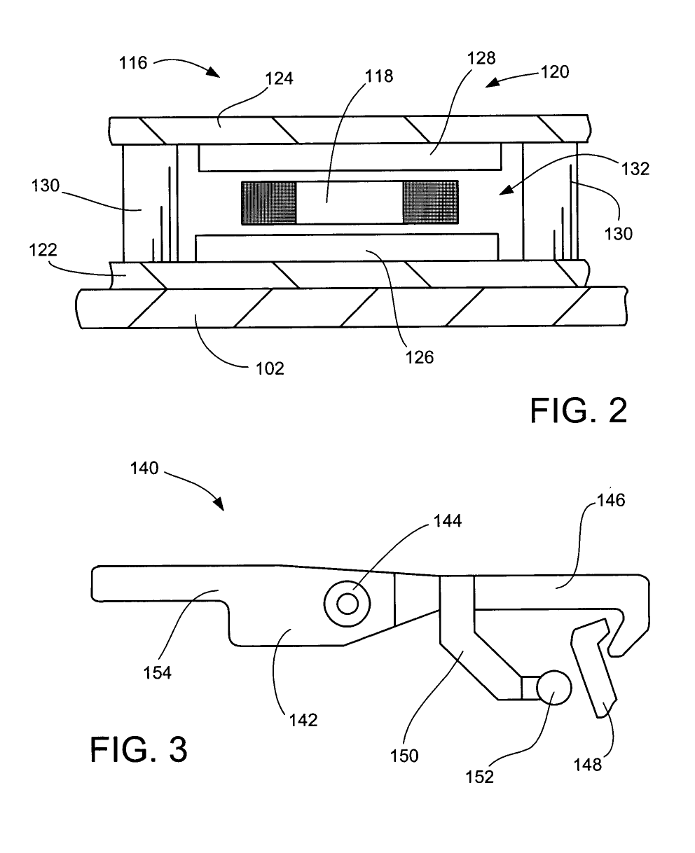

The VCM 116 includes an actuator coil 118 (partially shown) immersed in a magnetic field established by a magnetic circuit assembly 120. An elevational, generalized cross-sectional view of the VCM 116 is shown in FIG. 2. The magnetic circuit assembly 120 generally includes first and second (lower and upper) plate members 122, 124. The plate members, also referred to as pole pieces, are preferably formed of a magnetically permeable material such as stainless steel.

The plate members 122, 124 are shown to respectively support a pair of permanent magnets 126, 128. It will be understood that while FIG. 2 shows the magnetic circuit assembly 120 to include two magnets, other configurations can be employed including configurations that use a single magnet. The second plate member 124 is supported over the first member 122 by standoffs 130 to form a gap 132 in which the coil 118 is placed.

Application of current to the coil 118 generates electromagnetic fields that interact with the magnetic field of the magnetic circuit assembly 120. This results in the application of torque to the actuator 110, causing the actuator 110 to rotate about the cartridge bearing assembly 114. As the actuator 110 rotates, the heads 112 are moved across the disc surfaces.

When the disc drive 100 is deactivated, the VCM 116 preferably moves the actuator to a parked position so that the heads 112 are positioned over texturized contact start-stop (CSS) landing zones 130 at the innermost diameters of the discs 108, as shown in FIG. 1. The landing zones 130 are configured to allow the heads 112 to safely come to rest once the discs 108 have decelerated to a velocity insufficient to further aerodynamically support the heads.

An inertial latch 140 (partially shown in FIG. 1) operates to secure the actuator in the parked position. This prevents the inadvertent movement of the heads 112 out onto the disc surfaces while the disc drive is in a deactivated state.

A top plan representation of the latch 140 is shown in FIG. 3. The latch 140 includes a central body portion 142 and first and second (lower and upper) protrusions (only the upper protrusion is visible in FIG. 3, and is numerically denoted at 144). As discussed below, the latch 140 is captured in the gap 132 between the lower and upper plate members 124, 126 (FIG. 2), with the lower and upper protrusions nesting and rotating in associated apertures in the members.

The latch 140 is preferably characterized as an inertial latch, although such is not limiting to the scope of the invention as claimed below. More specifically, a latch arm 146 interacts with a corresponding feature 148 of the actuator 110 so that, when a nonoperational mechanical shock induces rotation in the actuator 110 in a first rotational direction, the latch arm 146 rotates in a second, opposite rotational direction to oppose movement of the actuator 110 away from the parked position.

In similar fashion, a nonoperational mechanical shock that induces rotation of the actuator 110 in the second direction causes the arm 146 to rotate in the first direction, again preventing movement of the actuator 110 away from the parked position. While any number of different configurations can be used for the latch 140, for clarity it will be noted that FIG. 3 shows the latch 140 to further include a limit arm 150 that contacts a stationary limit stop 152 mounted to the lower plate member 122 to limit rotational movement of the latch 140 to within a desired rotational range.

The latch 140 is further shown to include a counterbalance arm 154 which enables the latch 140 to rotate in a rotational direction opposite that of the actuator 110 in response to a nonoperational mechanical shock event. The latch 140 is preferably formed of a single continuous piece of material, such as injection molded plastic.

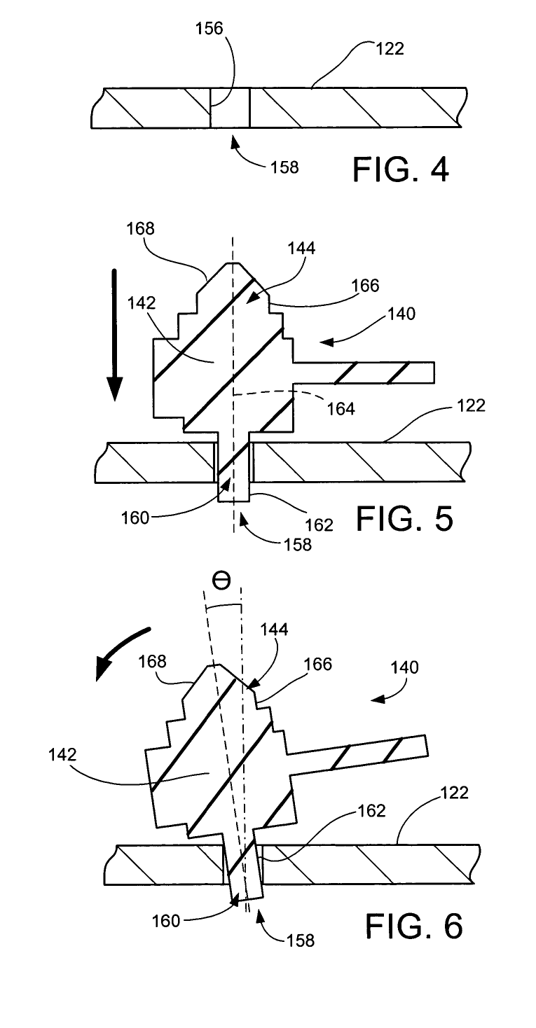

FIGS. 4-8 serve to illustrate the latch 140 in greater detail. It will be understood that various aspects of the latch 140 have been omitted from these figures for clarity of illustration.

As shown in FIG. 4, the first (lower) plate member 124 is provided with a first interior sidewall 156 which defines a first aperture 158. The aperture 152 is preferably annular in shape and fully extends through a thickness of the plate member 124.

The latch 132 (also more generally referred to as a “rotatable member”) is shown in FIG. 5 to include the aforementioned central body portion 134, the first (lower) protrusion (denoted at 160), and the second (upper) protrusion 144. The first protrusion 160 includes a first outer surface 162 sized to abut the first interior sidewall 156 and allow free rotation of the protrusion 160 within the first aperture 156. The first and second protrusions 160, 144 are axially aligned as represented by rotatable member axis 164.

As shown in FIGS. 5 and 6, the rotatable member 140 is brought into alignment with the first plate member 122 so that the first protrusion 160 extends into the first aperture 156. Because the first protrusion 160 has a diameter that is slightly smaller than the diameter of the first aperture 158, there is a likelihood that, once released, the rotatable member 140 will induce some amount of tilt (as represented by angle θ in FIG. 6). That is, opposing sides of the first protrusion 160 will tend to contact opposing sides of the first aperture 158 (as shown in FIG. 6) and the rotatable member 140 will “lean” to one side or the other.

The amount of tilt will depend on a number of factors including the respective nominal dimensions of the first interior sidewall 156 and the first outer surface 162, the thickness of the first plate member 122, respective manufacturing tolerances of these various surfaces, the location of the center of gravity of the rotatable member, and so on.

The relative orientation of the first plate member may also affect the amount of tilt induced in the rotatable member; for example, it can readily be seen that if the first plate member 122 is aligned along a substantially vertical orientation (instead of the substantially horizontal orientation shown in FIG. 6), then the pull of gravity upon the rotatable member will tend to induce a maximum amount of tilt in the member in a downward direction.

The second (upper) protrusion 144 is preferably configured to take this potential tilting of the rotatable member 140 into account. More particularly, the second protrusion 144 is shown in FIGS. 5 and 6 to include a second outer surface 164 and a tapering third outer surface 166 which converges from the second outer surface 164. Preferably, the diameter of the second outer surface 164 of the second protrusion 144 is greater than the diameter of the first outer surface 162 of the first protrusion 160. The tapering third outer surface 166 preferably tapers to a final diameter less than the diameter of the first outer surface 162.

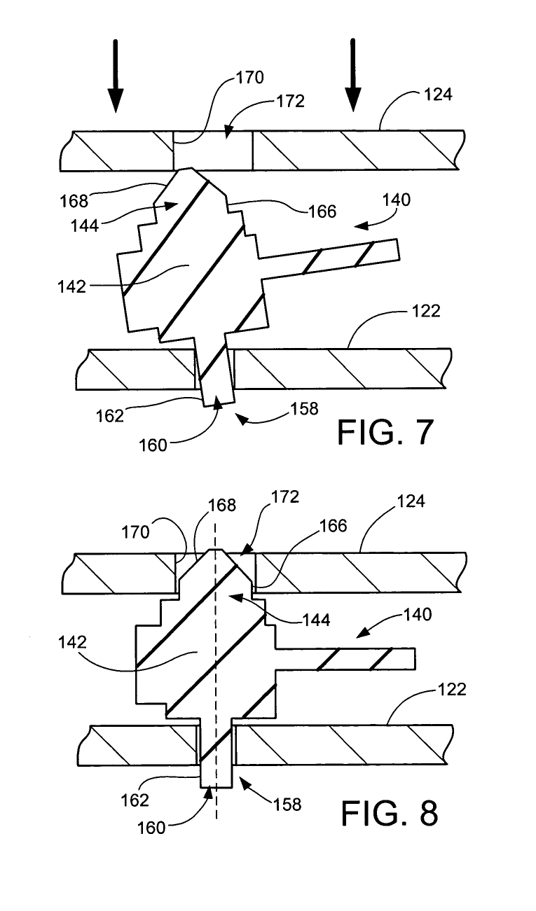

FIG. 7 shows the advancement of the second (upper) plate member 124 onto the rotatable member 140. The second plate member 124 includes a second interior sidewall 170 which defines a second aperture 172. As before, the second aperture 172 is preferably annular and fully extends through a thickness of the second plate member 124.

As the second plate member 124 is brought into alignment with the rotatable member 140, the second interior sidewall 170 contacts the tapered third outer surface 168. This allows the second plate member 124 to guide the second protrusion 144 into the second aperture 172 as the second plate member 124 is brought into axial alignment with the first plate member 122. The diameter of the second aperture 172 is further preferably selected to account for a maximum amount of tilt that may be induced in the rotatable member 140, thereby ensuring reliable and consistent insertion of the second plate member 124 onto the rotatable member 140. In this way, the rotatable member 140 is configured to be self aligning with the two plate members 122, 124.

Once the second plate member 124 is advanced to the final desired position, the rotatable member 140 is aligned as shown in FIG. 8. In this final alignment, the protrusions 160, 144 are axially aligned with and free to rotate within the apertures 158, 172, and the central body portion 142 is captured for rotation between the plate members 122, 124.

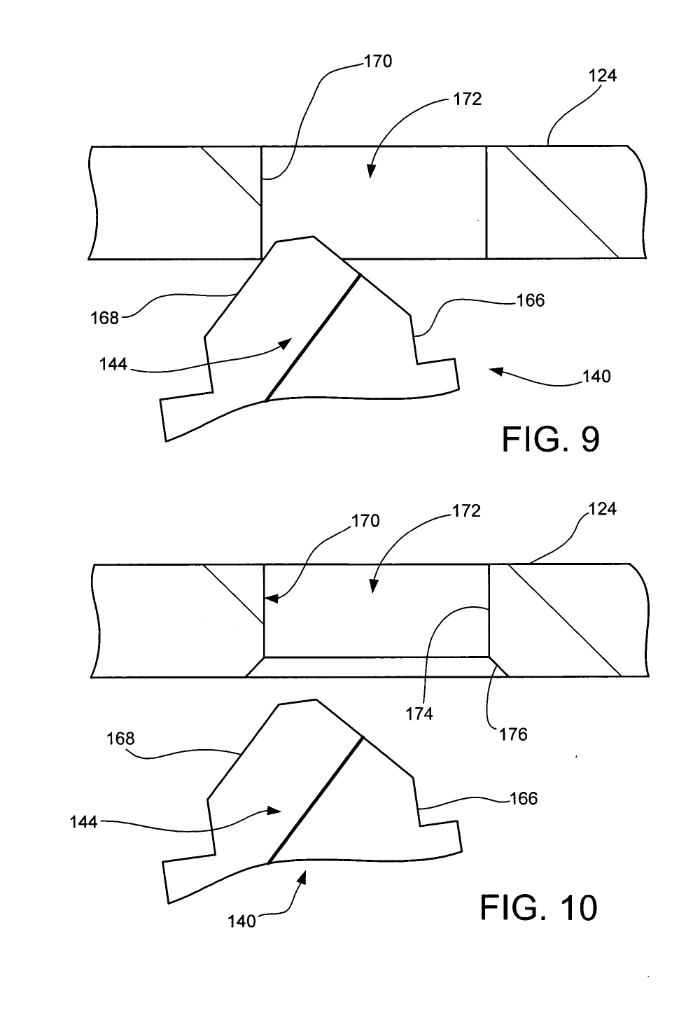

FIG. 9 shows in greater detail a preferred manner in which the second interior sidewall 170 contacts and slides along the tapered surface 166. As shown in FIG. 10, the second interior sidewall 170 can further be provided with an annular portion 174 configured to abut the second outer surface 166, and a chamfered leading portion 176 configured to engage the tapered surface 168. The chamfered leading portion 176 further ensures that proper alignment of the rotatable member 140 takes place during installation.

While the foregoing discussion has been directed to the configuration and installation of a rotatable latch in a data storage device, it will now be readily appreciated that the present invention (as claimed below) is not so limited. Rather, any number of different types of rotatable members arranged between opposing, aligned plate members can be utilized, including orientations that employ side-by-side, vertical alignment of the plate members (instead of the upper and lower, horizontal alignment shown in FIG. 2).

Moreover, the plate members do not necessarily require the use of flat planes; rather, curvilinearly and spherically extending plate members can also be employed as desired, as well as members that are discontinuous at locations away from areas adjacent the first and second apertures. Thus, the characterizations presented above of the rotatable member 140 as an inertial latch member and the first and second plate members as VCM pole pieces are for purposes of illustration and are not limiting.

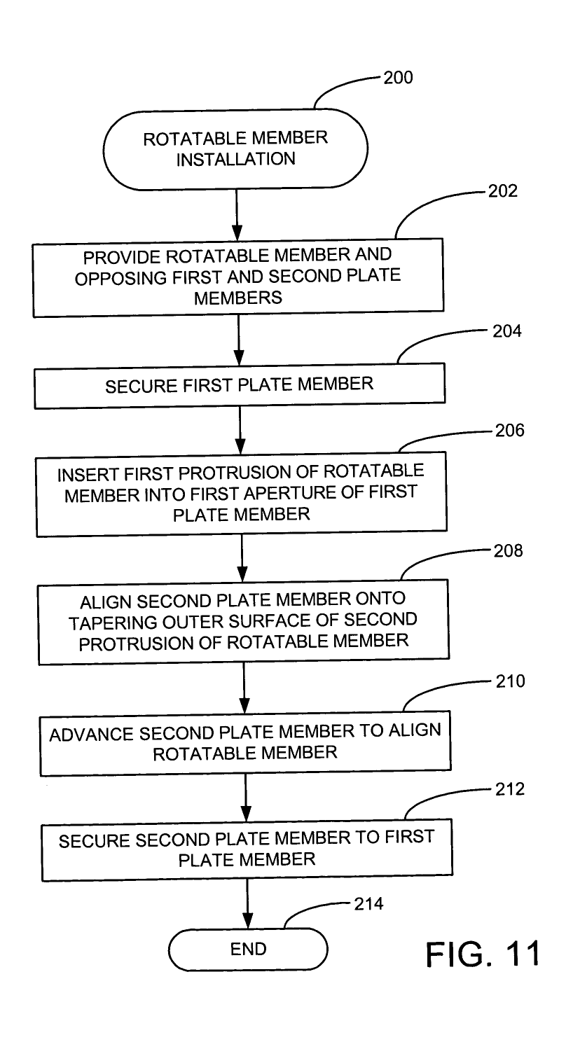

FIG. 11 provides a flow chart for an ROTATABLE MEMBER INSTALLATION routine 200 generally representative of steps carried out to configure and install a rotatable member such as 140 between opposing first and second plate members such as 122, 124.

As shown by step 202, the rotatable member and first and second plate members are provided with respective configurations as discussed above. The first plate member is held in place at step 204, as shown in FIG. 4. This can be accomplished by securing the first plate member in an appropriate fixture (not shown). When the first plate member comprises a lower VCM pole piece, step 204 can alternatively comprise securing the member to a base deck (such as 102).

At step 206, the first protrusion of the rotatable member is inserted into the first aperture. The resulting configuration will generally correspond to that shown in FIG. 6. Because the first protrusion is configured to rotate within the first aperture as discussed above, some amount of tilt in the rotatable member with respect to the first plate member may likely arise.

The second plate member is next aligned with the rotatable member at step 208 so that the second interior sidewall is placed onto the tapering outer surface of the second protrusion on the rotatable member. The second interior sidewall is then advanced along the tapered outer surface at step 210 to guide the second protrusion into the second aperture as the second plate member is brought into axial alignment with the first plate member.

Finally, as shown by step 212 the second plate member is secured with respect to the first plate member (such as by the standoffs 130 shown in FIG. 2) and the routine ends at step 214.

The configuration and installation of a rotatable member as discussed herein provides several advantages over the prior art. Component part costs and manufacturing tolerances can be reduced as compared to configurations that use a pressed stationary pin secured between the first and second plate members and a rotatable member secured for rotation around the pin.

The rotatable member can be formed as a single integral part using injection molding or other suitable processes, further reducing component costs.

Particulate matter generation is reduced or eliminated due to the ease with which the rotatable member is installed. That is, relatively small insertion forces are required to align the rotatable member between the plate members. No press fitting or swaging of components is required.

Further, the self-aligning features of the rotatable member greatly simplify the installation process and allows ready incorporation into automated assembly stations. It will be noted that in the assembly of VCM magnetic circuit assemblies (such as 120), very strong magnetic fields are generated by the permanent magnets. Thus, it can be difficult to guide the ends of a magnetically permeable, stationary press-fit pin into apertures in the pole pieces due to the strong magnetic attraction between the pin and the pole pieces. However, such difficulties are eliminated when the rotatable member is formed of a nonmagnetic material (such as plastic), since the first protrusion can be easily dropped into the first aperture without any magnetic attraction between the first protrusion and the pole piece.

It will now be understood that the present invention (as embodied herein and as claimed below) is generally directed to an apparatus comprising a self-aligning rotatable member (such as 140) arrangeable between opposing first and second plate members (such as 122, 124), and a method of installation thereof (such as 200).

In accordance with preferred embodiments, the opposing first and second plate members comprise magnetically permeable VCM pole pieces and have respective first and second interior sidewalls (such as 156, 170) which define respective first and second apertures (such as 158, 172).

The rotatable member preferably comprises an actuator latch and includes a central body portion (such as 142) and opposing, axially aligned first and second protrusions (such as 160, 144) sized to rotate within the respective first and second apertures when the central body portion is placed in a gap (such as 132) between the first and second plate members.

The first protrusion preferably comprises a first outer surface (such as 162) sized to abut the first interior sidewall. The second protrusion preferably comprises a second outer surface (such as 166) sized to abut the second interior sidewall, as well as a tapering third outer surface (such as 168) which converges from the second outer surface.

The first, second and third outer surfaces are configured so that when the first protrusion is inserted into the first aperture, the second interior sidewall contactingly engages the third outer surface and guides the second protrusion into the second aperture as the second member is brought into axial alignment with the first member.

The apparatus further preferably comprises means for securing the second plate member with respect to the first plate member to capture the rotatable member between the first and second members (such as 130). Preferably, the first outer surface has a first diameter and the second outer surface has a second diameter greater than the first diameter. The third outer surface preferably tapers to a third diameter less than the first diameter.

Moreover, the second interior sidewall preferably includes an annular portion (such as 174) and a chamfered portion (such as 176) which extends from the annular portion. The annular portion is sized to surround and abut the second outer surface of the second protrusion, and the chamfered portion is configured to contact the third outer surface as the second protrusion is guided into the second aperture.

In further preferred embodiments, the method generally includes steps of providing a rotatable member and opposing first and second plate members as configured above (such as by step 202). The first protrusion is inserted into the first aperture (such as by step 206). The second interior sidewall is placed onto the tapered outer surface of the second protrusion (such as by step 208). The second interior sidewall is then advanced along the tapering outer surface to guide the second protrusion into the second aperture as the second plate member is brought into axial alignment with the first plate member (such as by step 210).

Preferably, an additional step is carried out to secure the second plate member with respect to the first plate member to capture the rotatable member between the first and second members (such as by step 212).

It will be clear that the present invention is well adapted to attain the ends and advantages mentioned as well as those inherent therein. While presently preferred embodiments have been described for purposes of this disclosure, numerous changes may be made which will readily suggest themselves to those skilled in the art and which are encompassed in the appended claims.

What is claimed is:

1. An apparatus, comprising:
opposing first and second plate members having respective first and second interior sidewalls to define respective first and second apertures therein; and
a rotatable member comprising a central body portion and opposing, axially aligned first and second protrusions sized to rotate within the respective first and second apertures when the central body portion is placed in a gap between the first and second plate members, the first protrusion comprising a first outer surface sized to abut the first interior sidewall, the second protrusion comprising a second outer surface sized to abut the second interior sidewall and a tapering third outer surface which converges from the second outer surface,
wherein the first, second and third outer surfaces are configured so that when the first protrusion is inserted into the first aperture, the second interior sidewall contactingly engages the third outer surface and guides the second protrusion into the second aperture as the second plate member is brought into axial alignment with the first plate member.

2. The apparatus of claim 1, further comprising means for securing the second plate member with respect to the first plate member to capture the rotatable member between the first and second plate members.

3. The apparatus of claim 1, wherein the first outer surface has a first diameter and the second outer surface has a second diameter greater than the first diameter.

4. The apparatus of claim 3, wherein the third outer surface tapers to a third diameter less than the first diameter.

5. The apparatus of claim 1, wherein the first and second plate members comprise magnetically permeable pole pieces used in a magnet assembly of a voice coil motor to rotate an actuator.

6. The apparatus of claim 5, wherein the rotatable member comprises a latch which rotates to secure the actuator in a parked position.

7. The apparatus of claim 1, wherein the rotatable member is formed of plastic.

8. The apparatus of claim 1, wherein the second interior sidewall has an annular portion and a chamfered portion extending from the annular portion, wherein the annular portion is sized to surround and abut the second outer surface of the second protrusion, and wherein the chamfered portion is configured to contact the third outer surface as the second protrusion is guided into the second aperture.

9. A method, comprising:
providing a rotatable member and opposing first and second plate members, the first and second plate members having respective first and second interior sidewalls to define respective first and second apertures therein, the rotatable member comprising a central body portion and opposing, axially aligned first and second protrusions sized to rotate within the respective first and second apertures;
inserting the first protrusion into the first aperture;
placing the second interior sidewall onto a tapering outer surface of the second protrusion; and
advancing the second interior sidewall along the tapering outer surface to guide the second protrusion into the second aperture as the second plate member is brought into axial alignment with the first plate member.

10. The method of claim 9, further comprising subsequently securing the second plate member with respect to the first plate member to capture the rotatable member between the first and second plate members.

11. The method of claim 9, wherein the providing step comprises providing the first outer surface with a first diameter and the second outer surface with a second diameter greater than the first diameter.

12. The method of claim 11, wherein the providing step further comprises configuring the third outer surface to taper to a third diameter less than the first diameter.

13. The method of claim 9, wherein the first and second plate members of the providing step comprise magnetically permeable pole pieces used in a magnet assembly of a voice coil motor to rotate an actuator.

14. The method of claim 13, wherein the rotatable member of the providing step comprises a latch which rotates to secure the actuator in a parked position.

15. A method for assembling a data storage device, comprising:
supplying opposing, magnetically permeable lower and upper pole pieces having respective first and second interior sidewalls to define respective lower and upper apertures therein;
providing a rotatable latch member comprising a central body portion and opposing, axially aligned lower and upper protrusions sized to rotate within the respective lower and upper apertures, the latch member configured to secure an actuator of the data storage device in a parked position;
inserting the lower protrusion into the lower aperture;
placing the second interior sidewall onto a tapering outer surface of the upper protrusion; and
advancing the second interior sidewall along the tapering outer surface to guide the upper protrusion into the second aperture as the upper pole piece is brought into axial alignment with the lower pole piece.

16. The method of claim 15, further comprising subsequently securing the upper pole piece with respect to the lower pole piece to capture the rotatable latch member between the upper and lower pole pieces.

17. The method of claim 15, further comprising securing the lower pole piece to a base deck of the data storage device.

18. The method of claim 15, wherein providing step comprises configuring the first outer surface with a first diameter and the second outer surface with a second diameter greater than the first diameter.

19. The method of claim 18, wherein the providing step further comprises configuring the third outer surface to taper to a third diameter less than the first diameter.
